(19) United States
(12) Patent Application Publication
(10) Pub. No.: US 2019/0224685 A1
(43) Pub. Date: Jul. 25, 2019

(54) SPILL RESISTANT SAMPLE HOLDER

(71) Applicant: Giuseppe Benenati, Glendale, NY (US)

(72) Inventor: Giuseppe Benenati, Glendale, NY (US)

(21) Appl. No.: 16/253,499

(22) Filed: Jan. 22, 2019

Related U.S. Application Data
(63) Continuation of application No. 62/620,741, filed on Jan. 23, 2018.

(51) Int. Cl. B01L 9/06

(52) U.S. Cl. CPC B01L 9/06; B01L 3/5453

(57) ABSTRACT

A sample holder with a broad base that is resistant to spills is provided. The sample holder can hold specimen containers that allows for easy analysis of multiple samples while also decreasing the risk of spilling said samples. The sample holder also provides for easy analysis for multiple samples at the same time.

### CLAIM OF PRIORITY

This application claims priority to U.S. Patent Application No. 62/620,741 filed Jan. 23, 2018.

### BACKGROUND OF THE INVENTION

The invention relates to a sample holder for specimen containers, such as test tubes, that allows for easy analysis of multiple samples while also decreasing the risk of spilling said samples.

Previous sample holders have certain disadvantages. Currently available sample holders are prone to spilling. For example, spilling often occurs when specimen samples are collected and placed in the holder, such as when specimen samples are taken from fresh or salt water tanks used to hold and study fish and other marine life. Spilling can also occur after specimen samples are placed in a sample holder, for example when the chemical and physical properties of specimen samples are tested using reagents or assays. Such spillage during testing can occur when reagents or assays are added to the samples, when samples are removed from or returned to the sample holder to facilitate testing, or otherwise during the course of testing. Moving traditional sample holders from place to place may also result in spillage of specimen samples. To the extent that any specimen samples may need to be heated or illuminated during testing, those samples and other samples contained in the holder may also be prone to spillage or loss. Severe spillage before, during, or after testing might even undermine the structural integrity of the sample holder.

There is a need for a sample holder which reduces the likelihood of a user confusing one sample with another in the course of sample testing. For example, when specimen samples are collected and placed in the holder, it may be necessary or appropriate to identify the date, time, location, or conditions of the sampling. In those cases, it can be important to avoid confusing the date, time, location, or conditions of one sample with other samples. In the course of sample testing, different reagents or assays may also be used on the same, similar, or different samples. In such cases it can be important to apply the correct reagent or assay to each sample, and it can also be important to identify and record which reagent or assay has been applied to each sample.

There is also a need for a sample holder to provide easy analysis for multiple samples at the same time. It may be important to group or collect certain samples in certain locations, so that similar samples or similar assays, reagents, or tests are collected together. Furthermore, some assays, reagents, or tests may require larger or smaller specimen samples than others, so that different sizes of multiple samples may be necessary.

### BRIEF SUMMARY OF THE INVENTION

It is therefore an object of the invention to provide an improved sample holder that allows for easy analysis of multiple samples while also decreasing the risk of spilling said samples. The present invention has solved the problem of having a convenient way to analyze multiple samples testing for different parameters, while reducing the likelihood of spilling or the likelihood of a user confusing one sample with another.

In one embodiment, the sample holder is designed to facilitate the water chemistry maintenance testing process of aquariums, both salt and fresh water, where water chemistry testing is needed or desired.

The analysis of saltwater environments, such as a saltwater fish tank, presents the above problems. To properly maintain the saltwater environment, a number of components must be measured and adjusted on a regular basis. These components include pH, potassium levels, sodium levels, phosphate levels, ammonia levels, nitrite levels, nitrate levels, calcium levels, and heavy metal levels.

### BRIEF DESCRIPTION OF THE DRAWINGS

FIG. 1 shows a top-down angled view of the non-powered Sample Holder.

FIG. 2 shows a top-down view of the non-powered Sample Holder.

FIG. 3 shows a side view of the non-powered Sample Holder with a shaded depiction of test tubes in the Sample Holder.

FIG. 4 shows a back view of the non-powered Sample Holder.

FIG. 4B shows a side view of the non-powered Sample Holder with a dashed depiction of empty spaces in the Sample Holder

FIG. 5 shows a top-down angled view of the Sample Holder with digital buttons and a shaded depiction of test tubes in the Sample Holder.

FIG. 6 shows a top-down view of the Sample Holder with digital buttons.

FIG. 7 shows a side view of the Sample Holder with digital buttons with a shaded depiction of test tubes in the Sample Holder.

FIG. 8 shows a back view of the Sample Holder with digital buttons with a depiction of the power button and input/output port.

FIG. 9 shows a top-down angled view of the Sample Holder with an integrated touch screen.

FIG. 10 shows a top-down view of the Sample Holder with an integrated touch screen.

FIG. 11 shows a side view of the Sample Holder with an integrated touch screen with a shaded depiction of test tubes in the Sample Holder.

FIG. 12 shows a back view of the Sample Holder with an integrated touch screen with a depiction of the power button and input/output port.

### DETAILED DESCRIPTION OF THE INVENTION

Sample Holder presently described as the invention contained herein.

The Sample Holder provides a repository for temporary storage and analysis of samples, for example, samples held in multiple test tubes. The Sample Holder can be configured to hold multiple samples at one time. For example, the Sample Holder can hold 5 samples, 6 samples, 10 samples, 12 samples, 15 samples, 18 samples, 19 samples, 20 samples, 21 samples, 24 samples, 25 samples, 28 samples, or any other number of samples desired.

In one embodiment, the Sample Holder has means to identify each unique individual repository. These means can include, for example, digital numbers, letters, colors, codes, or the like. The Sample Holder has means to change the identifier as needed by the user.

In a preferred embodiment, the Sample Holder is used to analyze multiple components of a saltwater environment. These components can include, for example, pH, potassium levels, sodium levels, phosphate levels, ammonia levels, nitrite levels, nitrate levels, calcium levels, heavy metal levels or any other levels, reagents, or assays that may be tested or monitored.

In a preferred embodiment, the Sample Holder provides an attached shelf or workspace for reviewing the results of assays and recording the results.

In a preferred embodiment, the Sample Holder provides a digital storage and management device for recording the results of assays, including the date and time of an assay, the specific measurement made in the assay, and pertinent conditions such as temperature, salinity, the results of related assays, or other features of an assay.

In a preferred embodiment, the Sample Holder provides a digital storage and management device having a touchscreen and sufficient computing power to calculate variables relevant to an assay, including for recording the specific measurement(s) made in an assay, for recording the date and time of an assay, and for recording pertinent conditions such as temperature, salinity, the results of related assays, or other features of an assay. The touchscreen may or may not be integrated with the Sample Holder.

The Sample Holder can be made from materials well known in the art. Non-limiting examples include plastics, Plexiglas, aluminum, stainless steel, wood, or other eco-friendly or bio-degradable materials. The Sample Holder can be transparent, semi-transparent or opaque depending on the needs of the user. In one embodiment, the Sample Holder can be injection molded from a transparent, semi-transparent or opaque plastic material. The Sample Holder can be fabricated from a solid piece of material, or in the alternative, can be fabricated from multiple pieces of material that fit together or connect.

In one embodiment the base of the Sample Holder has a heated basin to enable samples to maintain a non-room temperature environment. In another embodiment, each row or column of the Sample Holder has a separate temperature control means.

In one embodiment, the Sample Holder 7 has one or more storage reservoirs. These reservoirs can hold, for example, a large quantity of sample that can be used to fill multiple sample testing tubes. These reservoirs can also hold, for example, fresh water or other solvent which can be used to clean contaminated sample testing tubes for further use. In one embodiment, the reservoirs can be part of the Sample Holder 7. In another embodiment, the Sample Holder can have means for temporarily storing removable reservoirs.

In one embodiment, the Sample Holder contains one or more internal storage compartments for storing and securing, for example, sample testing tubes. In another embodiment, the Sample Holder contains a storage slot that can hold test charts and/or test guideline sheets that allow the user to view the chart or sheet at the same time as the sample testing tubes.

In one embodiment, the Sample Holder has a vibrating base or vibrating slot that can mix the sample in the sample testing tubes and/or the reservoirs. In another embodiment, the Sample Holder has means for sonicating a sample in the sample testing tubes and/or the reservoirs.

In one embodiment, the Sample Holder has an extendable or articulating arm light for viewing samples in low light environments. The arm light can, for example, collapse into the Sample Holder or fold on top of the sample holder.

In one embodiment, the Sample Holder has means for preventing accidental falls and spills. Such means can include, for example, suction cups on the base of the Sample Holder or a textured material, such as rubber, that creates a skid proof base. The broad structure of the sample holder, in comparison to available test tub holders, also reduces the likelihood of accidental spills.

In one embodiment, the Sample Holder can have handles as part of the body of the sample holder. The handles can also be attached to the sample holder in ergonomic and/or balanced locations of the Sample Holder that enables secure transporting of the sample holder.

In one embodiment, an optional cover can be included with the Sample Holder. In another embodiment, a cover can be designed into the Sample Holder. The cover can be attached, for example, via a hinge mechanism or a slide/lock mechanism or other means known in the art.

In one embodiment, each individual sample testing tube holder opening 4 has means to keep a secure grip of the test tubes while testing that allows for easy insertion and removal. Such means can include, for example, rings made of a gripping material, such as rubber, or grommets. The rings or grommets create a grip around the sample testing tube that decreases the chances of accidental breakage from falls due to tipping, transportation of the Sample Holder, or cleaning of the sample testing tubes.

In one embodiment, the Sample Holder has electronic capabilities, including volatile and/or non-volatile memory, a processor, a storage device, a display, and input/output ports.

In one embodiment, the Sample Holder has an internal hard drive or flash memory drive capable of storing data. Such data includes, for example, test results, dates, test instructions, sample descriptions and other data gathered by use of the Sample Holder. In another embodiment, the Sample Holder has a slot or port capable of interacting with an external source such as, for example, a hard drive, USB drive, memory card, smart phone, tablet, and the like.

In one embodiment, the Sample Holder is powered by an internal rechargeable battery, for example, a lithium ion rechargeable battery. In another embodiment, the Sample Holder is powered by an outside electrical source, such as a 5V, 12V, 110V, or 220V electrical source. In another embodiment, the Sample Holder is powered by a conventional battery. In another embodiment, the Sample Holder is powered by solar power using solar cells. In another embodiment, the Sample Holder is powered by two or more of the above power options.

In one embodiment, the Sample Holder can have means to connect to a computer, tablet, smartphone, or other device that can process data. The sample holder can have a connection port, such as a USB port or Thunderbolt port for such a connection. The Sample Holder can also have the ability to connect to other devices by means of Wifi, Bluetooth, or other non-wired connection.

In one embodiment, the Sample Holder has an interface that a user can use to interact with the sample holder, for example, an on/off switch, timer settings, test logging, a timer stop, and the like. In another embodiment, the Sample Holder has a touch screen that allows for a user to interact with the sample holder. In another embodiment, the touch screen is waterproof. In another embodiment, the Sample Holder has an audio and/or visual indicator indicating timer completion.

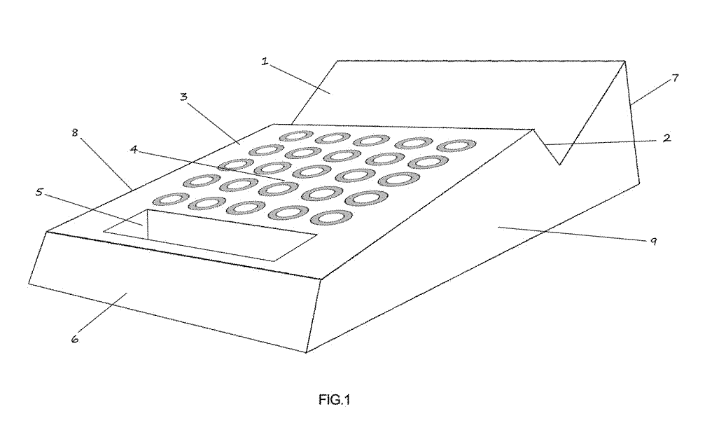

For a more detailed description of one preferred embodiment of the Sample Holder, turn to a consideration of FIG. 1. Sample Holder 7 is provided which contains sample holes 4 that have rubber grommets to securely grip the samples. The sample holes 4 extend through most of the depth of the Sample Holder. The sample holes 4 contain round rubber grommets located 0.1 mm to 2 mm from the top of the sample hole. The rubber grommets provide insurance against a sample slipping or spilling, and provides added strength to the sample. Sample holes 4 can be formed in straight lines of row and columns or be staggered. Sample holes 4 can the same or different sizes in diameter and depth.

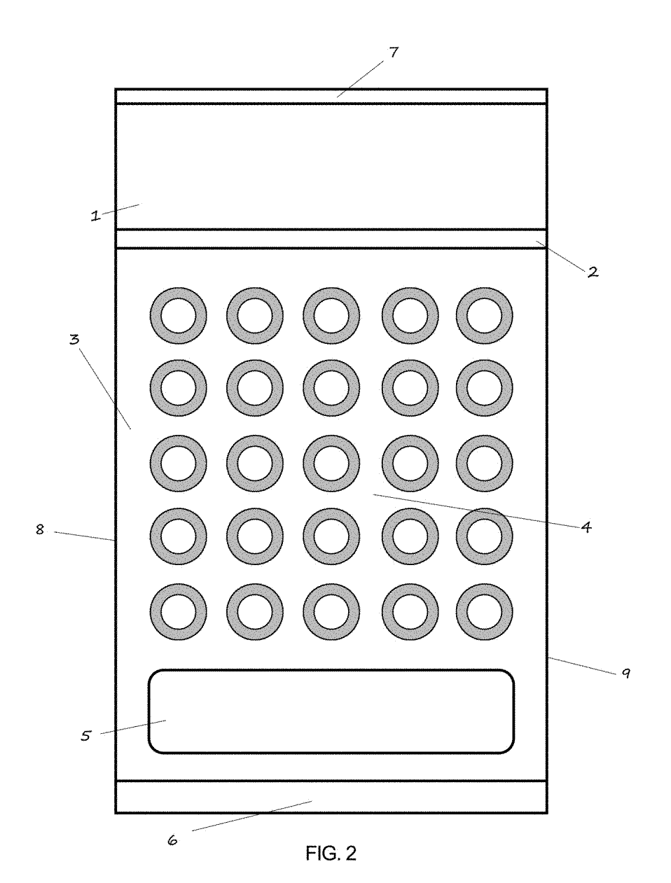

As shown in FIGS. 1 to 4B, Sample Holder 7 is provided with a surface 1 that can be used, for example, as a surface for recording data on a card or tablet.

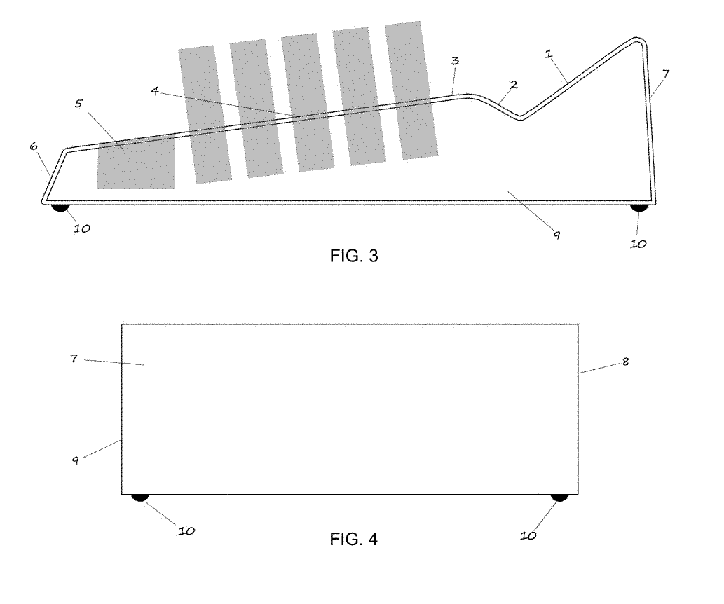

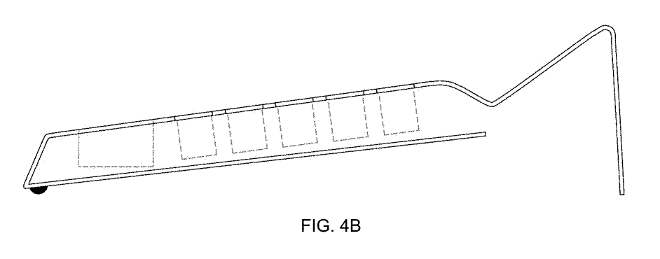

As shown in FIG. 3, Sample Holder 7 is inclined and can be made of one solid piece. FIG. 3 shows a shaded portion to represent test tubes in Sample Holder 7. FIG. 4B shows a dashed portion to represent spaces in Sample Holder 7 in which test tubes can be situated. Water basin 5 is situated below the sample holes 4. Sample Holder 7 is provided with feet 10 to provide stability and reduce slippage. The feet 10 may be of any suitable material, such as rubber or plastic.

As shown in FIG. 1, Sample Holder 7 may be provided with side panels, such as side panel 9.

Sample Holder 7 can be configured so that either the rows or columns of sample holders are removable. This allows the user flexibility for the testing of samples.

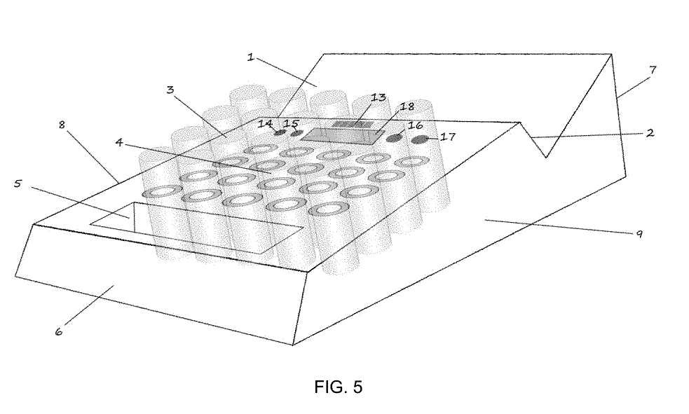

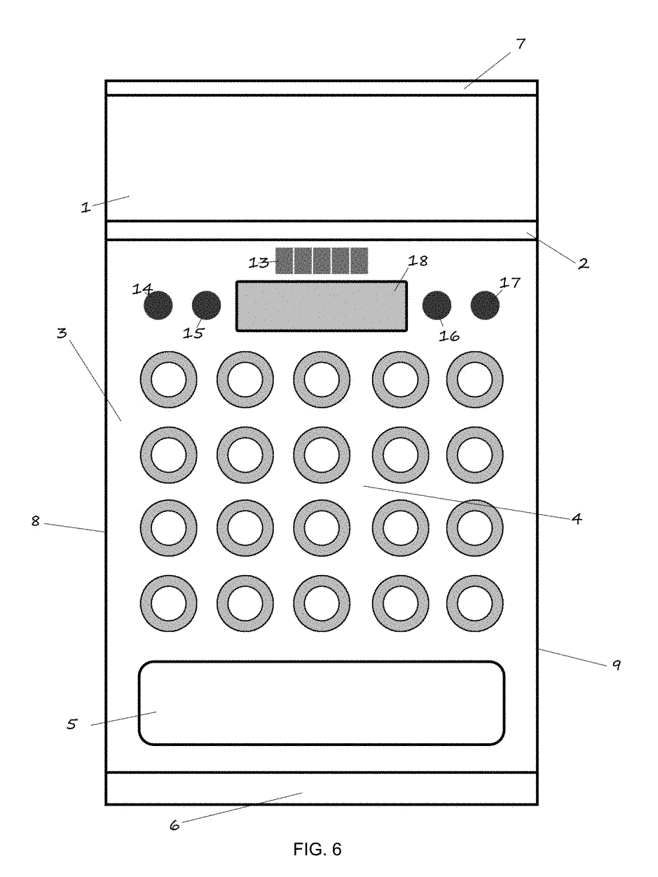

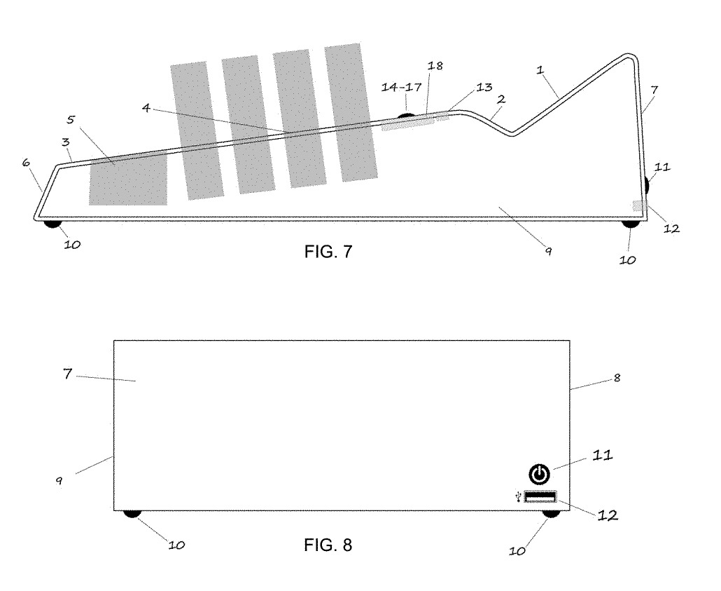

For a more detailed description of another preferred embodiment of the Sample Holder, turn to a consideration of FIGS. 5 to 8, which is similar to the previous embodiment but in addition has located above the sample holes a display output 18 and control buttons 14, 15, 16, and 17.

As shown in FIGS. 5 and 6, solar panels 13 are located above the display output 18 to power the display output and related electronics, including circuitry configured for processing and control buttons 14, 15, 16, and 17.

As shown in FIG. 8, the power button 11 is located on the rear of the Sample Holder. An input/output port 12 in the form of a USB port is also located on the rear of the Sample Holder.

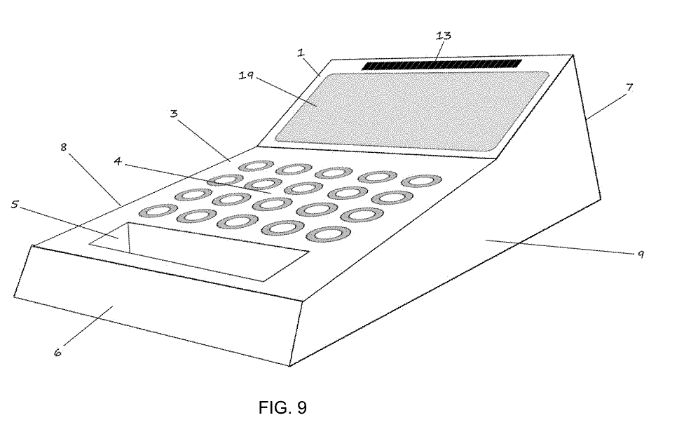

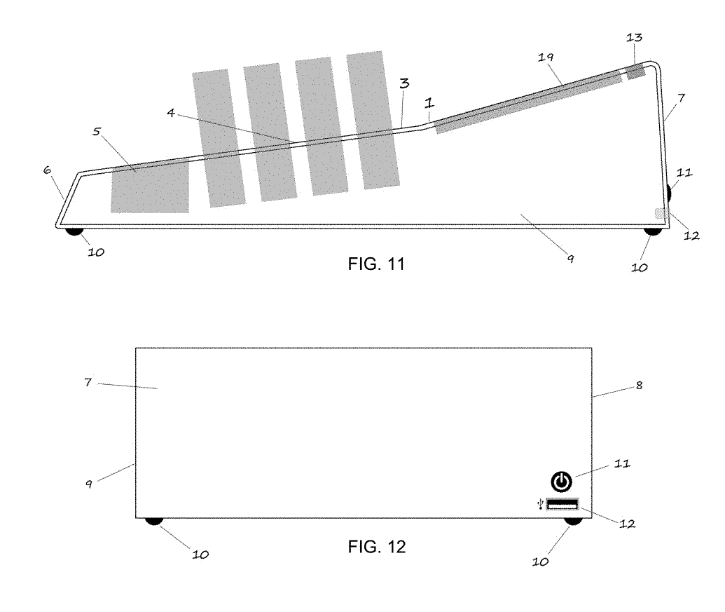

For a more detailed description of another preferred embodiment of the Sample Holder, turn to a consideration of FIGS. 9 to 12, which is similar to the previous two embodiments but has an integrated touchscreen display 19.

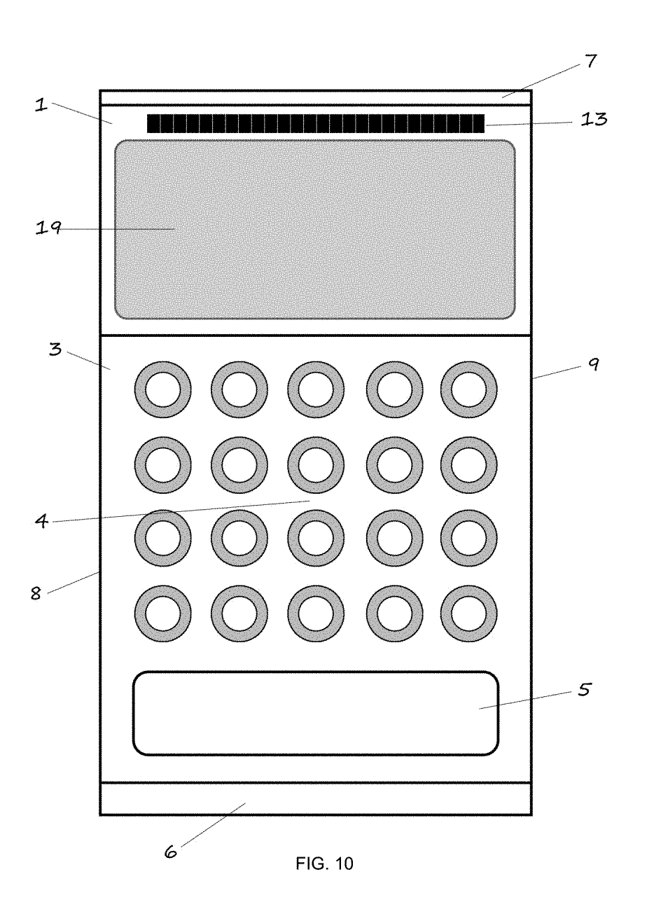

As shown in FIGS. 9 and 10, solar panels 13 are located above the integrated touchscreen display 19 to power the integrated touchscreen display and related electronics, including circuitry configured for processing.

As shown in FIG. 12, the power button 11 is located on the rear of the Sample Holder. An input/output port 12 in the form of a USB port is also located on the rear of the Sample Holder.

1. A broad structured sample holder that is resistant to spills and capable of holding multiple samples.

2. The sample holder of claim 1, wherein the sample holder is made of plastics, Plexiglas, aluminum, stainless steel, wood, or other eco-friendly or bio-degradable materials.

3. The sample holder of claim 1, wherein the sample holder is transparent, semi-transparent or opaque.

4. The sample holder of claim 1, wherein the sample holder provides a digital storage and management device having a touchscreen and sufficient computing power to calculate variables relevant to an assay.

5. The sample holder of claim 1, wherein each row or column of the sample holder has a separate temperature control.

6. The sample holder of claim 1, wherein the sample holder has one or more storage reservoirs.

7. The sample holder of claim 1, wherein the sample holder has one or more internal storage compartments.

8. The sample holder of claim 1, wherein the sample holder comprises a vibrating base or one or more vibrating slots.

9. The sample holder of claim 1, wherein the sample holder comprises an extendable or articulating arm light.

10. The sample holder of claim 1, wherein the sample holder comprises suction cups or a textured base material.

11. The sample holder of claim 1, wherein each individual sample testing tube holder opening has means to keep a secure grip of the test tubes.

12. The sample holder of claim 11, wherein the secure grip material is made of rubber or grommets.

13. The sample holder of claim 1, wherein the sample holder comprises volatile and/or non-volatile memory, a processor, a storage device, a display, input ports, output ports, a hard drive, or a flash memory drive.

14. The sample holder of claim 1, wherein the sample holder comprises a slot or port.

15. The sample holder of claim 1, wherein the sample holder is powered by a power source selected from the group comprising an internal rechargeable battery, an outside electrical source, a conventional battery, solar cells, or combinations thereof.

16. The sample holder of claim 1, wherein the sample holder comprises a user interface.

17. The sample holder of claim 1, wherein the sample holder comprises a cover that is attached via a hinge mechanism or a slide/lock mechanism.

18. The sample holder of claim 1, wherein the sample holder has the ability to connect to other devices by means of Wifi, Bluetooth, or other non-wired connection.

19. The sample holder of claim 1, wherein one or more of the individual sample testing tube holders is removable.

20. A spill resistant sample holder that provides digital storage and management, having a water-proof touchscreen and sufficient computing power to calculate variables relevant to an assay and for recording pertinent conditions of the assay.
